(19) United States
(12) Patent Application Publication
(10) Pub. No.: US 2012/0211963 A1
(43) Pub. Date: Aug. 23, 2012

(54) ADJUSTABLE SPRING ASSEMBLY

(75) Inventor: Todd Rupert Muck, Fowlerville, MI (US)

(73) Assignee: Toyota Motor Engineering & Manufacturing North America, Inc., Erlanger, KY (US)

(21) Appl. No.: 13/029,195

(22) Filed: Feb. 17, 2011

(51) Int. Cl. B60G 17/02; B60G 11/04; B60G 11/107

(52) U.S. Cl. 280/124.174

(57) ABSTRACT

The present invention provides a suspension apparatus having a primary leaf spring and a secondary leaf spring. The primary leaf spring can have a pair of spaced-apart ends that are attached to a frame and the secondary leaf spring can have a pair of spaced-apart ends that are unattached to the frame. A movable block is also included, can be attached to the frame and is located proximate to one of the pair of unattached ends of the secondary leaf spring. The movable block is operable to move closer to and further away from the proximate unattached end of the secondary leaf spring.

### FIELD OF THE INVENTION

The present invention is related to a leaf spring assembly, and in particular, to an adjustable leaf spring assembly having a leaf spring in combination with a movable block that is attached to a frame.

### BACKGROUND OF THE INVENTION

Leaf springs are used in suspension systems for motor vehicles such as small utility vehicles, trucks, and the like. A pair of leaf springs can support a vehicle frame over an axle and absorb at least part of the vibrations experienced by the axle during traveling over rough roads. In addition, the leaf springs can provide a cost-effective suspension for vehicles carrying heavy loads.

Leaf springs generally have a linear load deflection curve or spring rate and as such are not adjustable when the vehicle is subjected to different road conditions, cargo weights, and the like. As such, a leaf spring suspension system can result in less than desired driver comfort when conditions such as road conditions and cargo weight fall outside of a range(s) used to “set up” the suspension system. Therefore, a suspension apparatus or system that uses leaf springs and affords adjustment of a leaf spring spring rate would be desirable.

### SUMMARY OF THE INVENTION

The present invention provides a suspension apparatus having a primary leaf spring and a secondary leaf spring. The primary leaf spring has a pair of spaced-apart ends that are attached to a frame and the secondary leaf spring has a pair of spaced-apart ends that are unattached to the frame. In addition, the secondary leaf spring is located between the primary leaf spring and the frame. A movable block is also included and can be attached to the frame and be located proximate to one of the pair of unattached ends of the secondary leaf spring. The movable block is operable to be moved closer to and further away from the proximate unattached end and thereby change a spring rate of the secondary spring after a load has been applied to the frame and the secondary leaf spring has contacted the movable block. Stated differently, the movable block can have a first position and a second position that afford for the secondary leaf spring to have a first spring rate and a second spring rate, respectively.

In some instances, the movable block can be bolted to the frame using one or more of a plurality of apertures within the frame, the plurality of apertures located such that the movable block can be bolted to the frame at the first position and the second position. In other instances, a rotatable cam can be included and be in contact with the movable block, the rotatable cam operable to rotate and move the movable block closer to and further away from the one proximate unattached end of the secondary spring. In still other instances, a mechanical screw in contact with the movable block can be included, the mechanical screw operable to rotate and move the movable block closer to and further away from the one proximate unattached end of the secondary spring. In still yet another instance, an air bladder in contact with or part of the movable block can be included, the air bladder operable to expand, contract, and move the movable block closer to and further away from the one proximate unattached end of the secondary leaf spring.

The suspension apparatus can include a stationary block that is attached to the frame and is proximate to another of the pair of spaced-apart unattached ends of the secondary leaf spring. In the alternative, the movable block can be a first movable block and a second movable block proximate to the another spaced-apart unattached end of the secondary spring can be included. It is appreciated that the second movable block is operable to be moved closer to and further away from the another unattached end and thus change the spring rate of the secondary spring after the load has been applied to the frame and the secondary leaf spring has contacted the first movable block and the second movable block.

A process for changing a spring rate for a suspension apparatus is also included, the process including providing a suspension apparatus as described above and then providing a load onto the frame. The load compresses the primary leaf spring until the movable block contacts the proximate unattached end of the secondary leaf spring, the secondary leaf spring having a first spring rate when the movable block is in the first position and a second spring rate when the movable block is in the second position.

### BRIEF DESCRIPTION OF THE DRAWINGS

FIG. 1 is a prior art view of a leaf spring device for a motor vehicle;

FIG. 2 is an enlarged view of the leaf spring device shown in FIG. 1;

FIG. 3 is a schematic illustration of a suspension apparatus according to an embodiment of the present invention;

FIG. 4 is a schematic illustration of a suspension apparatus according to another embodiment of the present invention;

FIG. 5 is a schematic illustration of a suspension apparatus according to another embodiment of the present invention; and

FIG. 6 is a schematic illustration of a suspension device according to another embodiment of the present invention.

### DETAILED DESCRIPTION OF THE PRESENT INVENTION

The present invention provides a suspension apparatus that includes a leaf spring assembly for a motor vehicle. As such, the present invention has utility as a component for a motor vehicle.

The suspension apparatus can include a primary leaf spring and a secondary leaf spring. The primary leaf spring has a pair of spaced-apart ends that are attached to a frame as is known to those skilled in the art. The secondary leaf spring can be located between the primary leaf spring and the frame and also have a pair of spaced-apart unattached ends. Attached to the frame and proximate to one of the unattached ends of the secondary leaf spring can be a movable block that is operable to move towards or away from the one unattached end. The movable block can be movably attached to the frame using any number of attachment mechanisms that afford for the block to be located in a first position and a second position, for example and for illustrative purposes only, a bolt and aperture attachment mechanism, a rotatable cam mechanism, a mechanical screw mechanism, an air bladder mechanism, and the like.

Upon applying a load onto the frame, the primary spring can compress such that the one unattached end of the secondary leaf spring approaches and comes into contact with the movable block. When the movable block is in the first position, the secondary leaf spring can have a first spring rate and when the movable block is in the second position, the secondary spring can have a second spring rate. In this manner, a user of the suspension apparatus can alter the spring rate of the secondary leaf spring, and the spring rate of an overall suspension system, in order to provide improved performance, comfort, and the like.

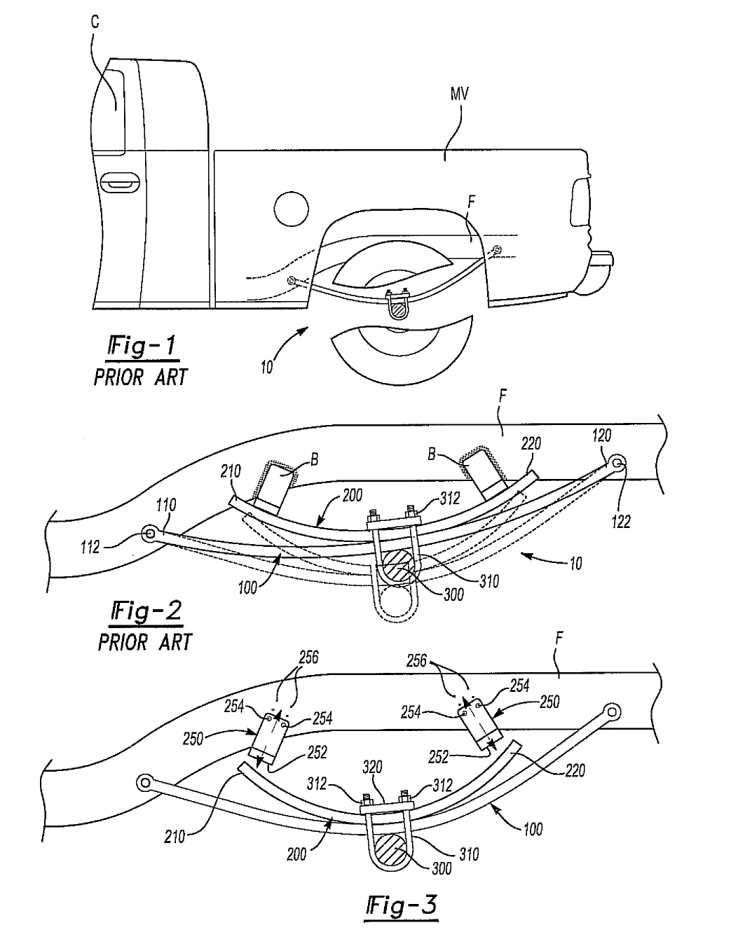

Turning now to the figures, FIG. 1 illustrates a motor vehicle MV having a leaf spring assembly 10. As shown in FIG. 2, the leaf spring assembly 10 can have a primary leaf spring 100 with a first end 110 and a second end 120, the first end attached to a frame F about a pivot axis 112 and the second end 120 can be attached to the frame F about a pivot axis 122. As illustrated by the phantom lines in FIG. 2, the secondary spring 200 has a first end 210 and a second end 220 that are unattached to the frame F.

A pair of blocks B can be fixedly attached to the frame F and located proximate to the first end 210 and the second end 220. Upon application of a load upon the frame F, the primary leaf spring 100 can be compressed in such a manner that the secondary leaf spring 200 moves toward the blocks B, and if the load is large or great enough, the first end 210 and the second end 220 can come into contact with the blocks B. As such, the frame F can accommodate normal or light loads using just the primary leaf spring 100, but incorporate the use of the secondary leaf spring 200 when heavier loads are applied to the frame.

Referring now to FIG. 3, an embodiment of the present invention includes at least one movable block 250 movably attached to the frame F and located proximate to the first end 210 and/or second end 220 of the secondary leaf spring 200. The movable block 250 can have its position adjusted using the plurality of apertures 256 within the frame F and one or more rods 254. It is appreciated that the rods 254 can be in the form of a bolt which can thread into the frame F, or in the alternative pass through the frame F and have a nut that threadingly engages the bolt.

The movable block 250 can have a spring surface 252 that can come into contact with the first end 210 or the second end 220 depending on the location of the block 250 and the amount of load applied to the frame F. In addition, with the movable block 250 operable to be attached to the frame F at a position that is either closer to or further away from the unattached end of the secondary leaf spring 200, the amount of load required to engage the secondary spring 200 can be altered. It is appreciated that by moving the blocks 250 closer to and further away from the first end 210 and/or the second end 220, the spring rate of the secondary spring 200 for a given load applied to the frame F can be changed.

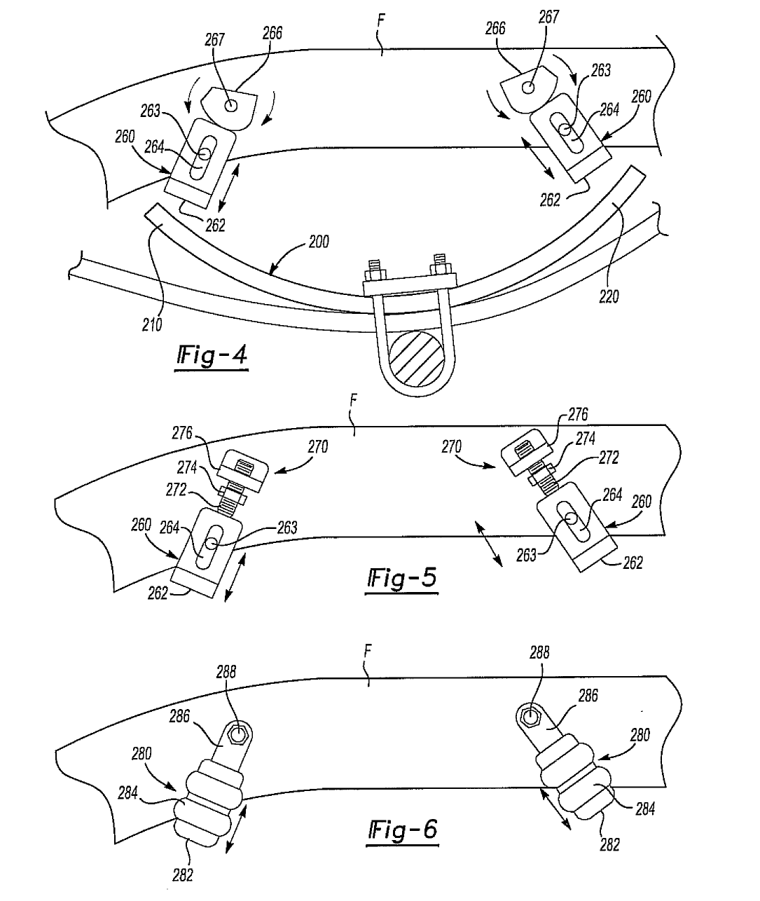

Referring now to FIG. 4, another embodiment of the present invention can include at least one movable block 260 and a cam 266 attached to the frame F, the cam 266 operable to afford movement of the block 260 towards and away from the first end 210 and/or the second end 220. The movable block 260 can have a slot 264 with a rod 263 that affords movement of the block 260 and a spring surface 262 in a direction as indicated by the double-headed arrow in the figure. The cam 266 can be in contact with the movable block 260 and rotation of the cam 266 as shown by the single-headed arrows can afford for the block 260 to be pushed towards the first end 210 and/or the second end 220 or withdrawn therefrom. It is appreciated that the rod 263 can be in the form of a threaded fastener such as a bolt and more than one rod 263 for each block 260, within or not within the slot 264, can be included. In addition, the cam 266 can have a threaded fastener or pin 267 such as a bolt in order to firmly attach the cam to the frame F. Also, the cam 266 can be motorized and rotatable using electrical, mechanical, pneumatic and/or hydraulic power.

FIG. 5 shows another embodiment in which the movable block 260 is in contact with a mechanical screw mechanism 270. It is appreciated that the secondary leaf spring 200 is not shown in the figure for convenience purposes only and that the movable block 260 is used with such a leaf spring. The mechanical screw mechanism 270 can afford for the block 260 to move towards and away from the first end 210 and/or the second end 220 of the secondary leaf spring 200. The mechanical screw mechanism 270 can include a threaded elongated pin or rod 272, a nut 274, and a threaded flange 276 that is attached to the frame F. The movable block 260, as stated above, can have a slot 264 with one or more rods 263 that afford for the block 260 to be located in a first position and a second position. Likewise, the first end 210 and/or second end 220 can come into contact with the spring surface 262, and depending upon the location of the block 260, the spring rate of the secondary spring 200 can be altered.

Referring now to FIG. 6, the suspension apparatus can include one or more movable blocks 280 that have a spring surface 282 and an air bladder 284. The air bladder 284 can be attached to a frame member 286, the frame member 286 attached to the frame F. For example and for illustrative purposes only, the frame member 286 can be attached to the frame F using a threaded fastener 288. The air bladder 284 can expand and contract as is known to those skilled in the art and thereby afford for the spring surface 282 to move towards or away from the secondary leaf spring 200 as indicated by the double-headed arrows in the figure. In addition, the air pressure within the air bladder 284 can be altered manually, remotely and/or automatically such that the location of the spring surface 282 can be altered. As such, the spring surface 282 can be moved closer to and further away from the first end 210 and/or the second end 220 and the stiffness or resistance force provided by the air bladder 284 can also be changed. In this manner, the spring rate of the secondary leaf spring 200 can be changed from a first spring rate to a second spring rate.

A process for changing the spring rate of the secondary leaf spring 200 can include providing the frame F and one or more of the embodiments shown in FIGS. 3-6. Thereafter, a force can be applied to the frame F, for example by hauling a load using the motor vehicle MV, with the load affording for compression of the primary leaf spring 100 such that the secondary leaf spring 200 comes into contact with one or more movable blocks as illustrated in the figures. When the movable block has a first position, the secondary leaf spring 200 has a first spring rate for a given load applied to the frame F. In addition, the movable block is moved from the first position to the second position, and thereby affords for the secondary leaf spring 200 to have a second spring rate for the given load.

It is appreciated that the primary leaf spring 100 and the secondary leaf spring 200 can be attached to an axle 300, for example using a U-shaped threaded fastener 310, a bolt 312, and a fastening plate 320. It is also appreciated that other attachment mechanisms can be used to attach the primary leaf spring 100 and the secondary leaf spring 200 to the frame F and/or to another load-bearing component such as the axle 300. In addition, the leaf spring assembly does not have to be part of a motor vehicle and can be used as part of any machine, apparatus, etc. that is subjected to a load and vibration force(s).

The frame, leaf springs and blocks can be made from any material known to those skilled in the art that provide desired mechanical properties for such components, illustratively including metals, alloys, plastics, elastomers, ceramics and the like. The invention is not restricted to the illustrative embodiments described above and the embodiments are not intended as limitations on the scope of the invention. Methods, processes, apparatus, compositions, and the like described herein are exemplary and not intended as limitations on the scope of the invention. Changes therein and other uses will occur to those skilled in the art. As such, the scope of the invention is defined by the scope of the claims.

I claim:

1. A suspension apparatus comprising:
a frame;
a primary leaf spring and a secondary leaf spring;
said primary leaf spring having a pair of spaced-apart ends attached to said frame and said secondary leaf spring having a pair of spaced-apart ends unattached to said frame, said secondary leaf spring located between said primary leaf spring and said frame;
a movable block attached to said frame and proximate one of said pair of unattached ends of said secondary leaf spring, said movable block operable to be moved closer to and further away from said one unattached end and change a spring rate of said secondary leaf spring after a load has been applied to said frame and said secondary leaf spring has contacted said movable block.

2. The suspension apparatus of claim 1, wherein said movable block is bolted to said frame through one of a plurality of apertures in said frame, said plurality of apertures located for said movable block to be bolted to said frame at a first position and a second position.

3. The suspension apparatus of claim 1, further comprising a rotatable cam in contact with said movable block, said rotatable cam operable to rotate and move said movable block closer to and further away from said one unattached end of said secondary leaf spring.

4. The suspension apparatus of claim 1, further comprising a mechanical screw in contact with said movable block, said mechanical screw operable to rotate and move said movable block closer to and further away from said one unattached end of said secondary leaf spring.

5. The suspension apparatus of claim 1, further comprising an air bladder in contact with said movable block, said air bladder operable to expand, contract and move said movable block closer to and further away from said one unattached end of said secondary leaf spring.

6. The suspension apparatus of claim 1, further comprising a stationary block attached to said frame proximate another of said pair of spaced apart unattached ends of said secondary leaf spring.

7. The suspension apparatus of claim 1, wherein said movable block is a first movable block and further comprising a second movable block proximate another of said pair of spaced apart unattached ends of said secondary leaf spring, said second movable block operable to be moved closer to and further away from said another unattached end and change the spring rate of said secondary leaf spring after the load has been applied to said frame and said secondary leaf spring has contacted said first movable block and said second movable block.

8. The suspension apparatus of claim 7, wherein said first movable block and second movable block can be moved closer to and further away from said one unattached end and said another attached end, respectively, using a movement mechanism selected from the group consisting of a bolt and aperture mechanism, a cam mechanism, a mechanical screw mechanism, an air bladder mechanism and combinations thereof.

9. The suspension apparatus of claim 8, wherein said first movable block and said second movable block are both bolted to said frame with said bolt and aperture mechanism.

10. The suspension apparatus of claim 8, wherein said first movable block and said second movable block both have said cam mechanism.

11. The suspension apparatus of claim 8, wherein said first movable block and said second movable block both have said mechanical screw mechanism.

12. The suspension apparatus of claim 8, wherein said first movable block and said second movable block both have said air bladder mechanism.

13. A process for changing a spring rate for a suspension apparatus, the process comprising:
providing a frame;
providing a primary leaf spring and a secondary leaf spring;
the primary leaf spring having a pair of spaced-apart ends attached to the frame and the secondary leaf spring having a pair of spaced-apart ends unattached to the frame, the secondary leaf spring located between the primary leaf spring and the frame;
providing a movable block attached to the frame and proximate one of the pair of unattached ends of the secondary leaf spring, the movable block operable to be moved closer to and further away from the proximate unattached end, the movable block having a first position and a second position;
providing a load onto the frame, the load compressing the primary leaf spring until the movable block contacts the proximate unattached end thereof, the secondary leaf spring having a first spring rate when the movable block is in the first position and a second spring rate when the movable block is in the second position.

14. The process of claim 13, wherein the movable block is bolted to the frame through one of a plurality of apertures in the frame, the plurality of apertures located for the movable block to be attached to the frame at the first position and the second position.

15. The process of claim 13, further including a rotatable cam in contact with the movable block, the rotatable cam operable to rotate and move the movable block between the first position and the second position.

16. The process of claim 13, further including a mechanical screw in contact with the movable block, the mechanical screw operable to move the movable block between the first position and the second position.

17. The process of claim 13, wherein the movable block has an air bladder that can expand and contract, the air bladder operable to move the movable block between the first position and the second position.

18. The process of claim 13, further comprising a stationary block proximate another of the pair of spaced apart unattached ends of the secondary leaf spring.

19. The process of claim 13, wherein the movable block is a first movable block and further including providing a second movable block proximate another of the pair of spaced apart unattached ends of the secondary leaf spring, the second movable block operable to move closer to and further away from the another unattached end.

20. The process of claim 19, wherein the first movable block and the second movable block can be moved closer to and further away from the one unattached end and the another attached end of the secondary leaf spring, respectively, using a movement mechanism selected from the group consisting of a bolt and aperture mechanism, a cam mechanism, a mechanical screw mechanism, an air bladder mechanism and combinations thereof.
